(19) United States
(12) Patent Application Publication
(10) Pub. No.: US 2006/0087256 A1
(43) Pub. Date: Apr. 27, 2006

(54) Bulb structure and manufacturing method of electrodeless lighting system

(75) Inventors: Byeong-Ju Park, Seoul (KR); Yun-Chul Jung, Gwangmyeong (KR); Joon-Sik Choi, Seoul (KR); Yong-Seog Jeon, Gwangmyeong (KR); Hyun-Jung Kim, Seoul (KR); Ji-Young Lee, Gwangmyeong (KR); Seung-Yeup Hyun, Seoul (KR); Dae-Kyung Kim, Seoul (KR); Ri-Na Hwang, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/029,421

(22) Filed: Jan. 6, 2005

(30) Foreign Application Priority Data
Oct. 26, 2004 (KR) 85952/2004

(51) Int. Cl. H01J 19/80

(52) U.S. Cl. 315/248; 315/246; 315/39

(57) ABSTRACT

A bulb structure of an electrodeless lighting system comprises: a bulb body having an interior space receiving a luminous material emitting light by microwave energy; a bulb support portion integrally extending from one side of the bulb body to communicate with the bulb body, supporting the bulb body, connected to a bulb rotating motor at its one end, and having therein a passage through which the luminous material is injected; and a covering portion formed at an inner communicating portion where the bulb body communicates with the bulb support portion so as to hermetically seal the bulb body, thereby improving light distribution characteristics of the electrodeless lighting system.

### BACKGROUND OF THE INVENTION

1. Field of the Invention

The present invention relates to a bulb of an electrodeless lighting system, and particularly, to a bulb structure and a manufacturing method of an electrodeless lighting system configured to improve light distribution characteristics.

2. Description of the Background Art

In general, an electrodeless lighting system is an apparatus emitting visible light or ultraviolet light from an electrodeless plasma bulb upon applying microwave energy to the bulb. The electrodeless lighting system has a long life span and good lighting effect compared with an incandescent lamp or a fluorescent lamp which is generally used.

FIG. 1 is a longitudinal sectional view showing one example of a conventional electrodeless lighting system.

As shown, the conventional electrodeless lighting system using microwave energy includes: a case 1 forming a certain interior space; a microwave generator 2 mounted in the case 1, for generating microwave energy; a waveguide 4 for guiding microwave energy generated from the microwave generator 2; a resonator 4 installed at an exit portion 4a of the waveguide 4, communicating therewith; and a bulb 5 positioned in the resonator 6, for generating light as a filling material becomes a plasma by the microwave energy transferred through the waveguide 4.

In addition, a reflecting mirror 7 for concentratively reflecting light generated from the bulb 5 to the front is provided in front of the case 1, namely, at a surrounding area of the resonator 6.

Undescribed reference mark 12 is a bulb motor for rotating the bulb 5, and 12a is a bulb motor rotating shaft.

The bulb 5 includes; a bulb body 5a having a certain interior space and formed as a spherical shape; and a bulb rotating shaft 5b extending from the bulb body 5a and coaxially coupled to the bulb motor rotating shaft 12a, for serving as a medium for rotation of the bulb body 5a according to the rotation of the bulb motor 12.

FIG. 2 shows a manufacturing method of a bulb of the conventional electrodeless lighting system, and FIG. 3 shows a bulb structure of the conventional electrodeless lighting system.

As shown in FIG. 2, a hollow pipe 8 communicating with an interior space of the bulb body 5a is formed at one side of the bulb body 5a, the opposite side of the bulb rotating shaft 5b.

A luminous material 9 is injected into the interior space of the bulb body 5a through the hollow pipe 8. After a proper amount of luminous materials 9 are introduced in the interior space of the bulb body 5a, the hollow pipe 8 is removed, and the portion communicating with the hollow pipe 8, of the bulb body 5a is covered. In this process, as shown in FIG. 3, a protrusion 5c is formed on the covered portion of the bulb body 5a.

However, the bulb of the conventional electrodeless lighting system having such a structure has the following problems. Because the protrusion remains at the bulb portion in the manufacturing process, part of light passes through the protrusion and is refracted thereby when light is emitted from the bulb to the outside. For this reason, the light distribution characteristic of the entire electrodeless lighting system is degraded, and its appearance does not look fine.

### SUMMARY OF THE INVENTION

Therefore, an object of the present invention is to provide a bulb structure and a manufacturing method of an electrodeless lighting system configured to improve light distribution characteristics.

To achieve these and other advantages and in accordance with the purpose of the present invention, as embodied and broadly described herein, there is provided a bulb structure of an electrodeless lighting system comprising: a bulb body having an interior space receiving a luminous material emitting light by microwave energy; a bulb support portion integrally extending from one side of the bulb body to communicate with the bulb body, supporting the bulb body, connected to a bulb rotating motor at its one end, and having therein a passage through which the luminous material is injected; and a covering portion formed at an inner communicating portion of the bulb body and the bulb support portion so as to hermetically seal the bulb body.

To achieve these and other advantages and in accordance with the purpose of the present invention, as embodied and broadly described herein, there is provided a bulb manufacturing method of an electrodeless lighting system comprising: a first step of integrally forming a bulb support portion having therein a passage for injection of the luminous material at one side of a bulb body having an interior space receiving a luminous material emitting light by microwave energy, the bulb support portion communicating with the bulb body; a second step of injecting the luminous material in the interior space of the bulb body through an injection passage of the bulb support portion; and a third step of forming a covering portion at an inner communicating portion where the bulb body communicates with the bulb support portion so that the interior space of the bulb body in which the luminous material is filled is hermetically sealed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a longitudinal sectional view showing a conventional electrodeless lighting system;

FIG. 2 is a sectional view showing a manufacturing method of a bulb of the conventional electrodeless lighting system;

FIG. 3 is a sectional view showing a bulb structure of the conventional electrodeless lighting system;

FIG. 4 is a longitudinal sectional view showing an electrodeless lighting system in accordance with one embodiment of the present invention;

FIG. 5 is a perspective view showing a bulb of the electrodeless lighting system in accordance with one embodiment of the present invention;

FIG. 6 is a longitudinal sectional view of FIG. 5;

FIGS. 7 and 8 are longitudinal sectional views showing a manufacturing process of the bulb in accordance with one embodiment of the present invention; and

FIG. 9 is a longitudinal sectional view showing a bulb structure in accordance with another embodiment of the present invention.

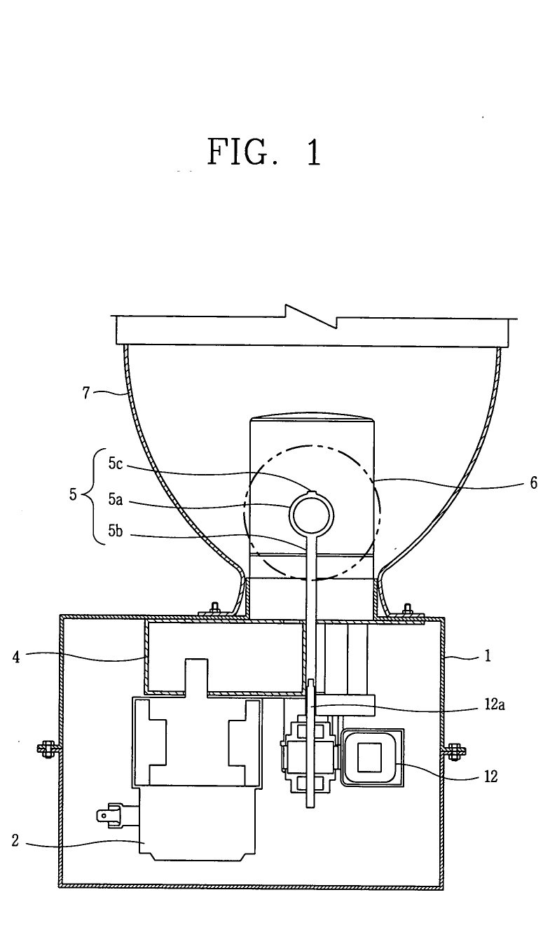

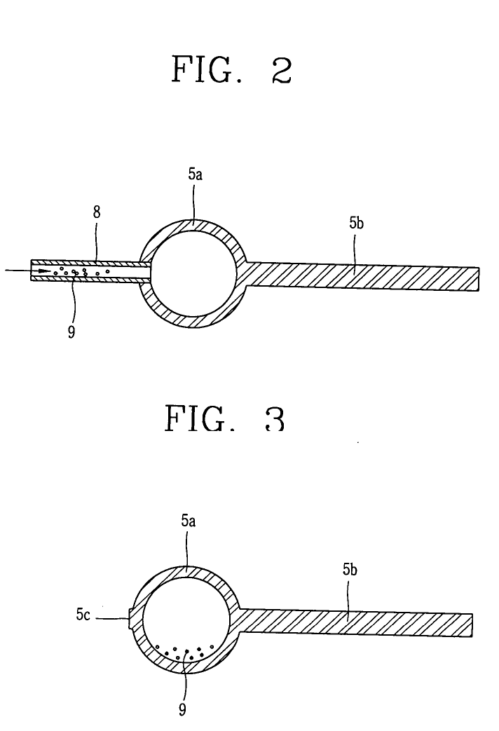

### DETAILED DESCRIPTION OF THE PREFERRED EMBODIMENTS

Reference will now be made in detail to the preferred embodiments of the present invention, examples of which are illustrated in the accompanying drawings.

There may be a plurality of embodiments of a bulb of an electrodeless lighting system in accordance with the present invention, and hereinafter, the most preferred embodiment will be explained.

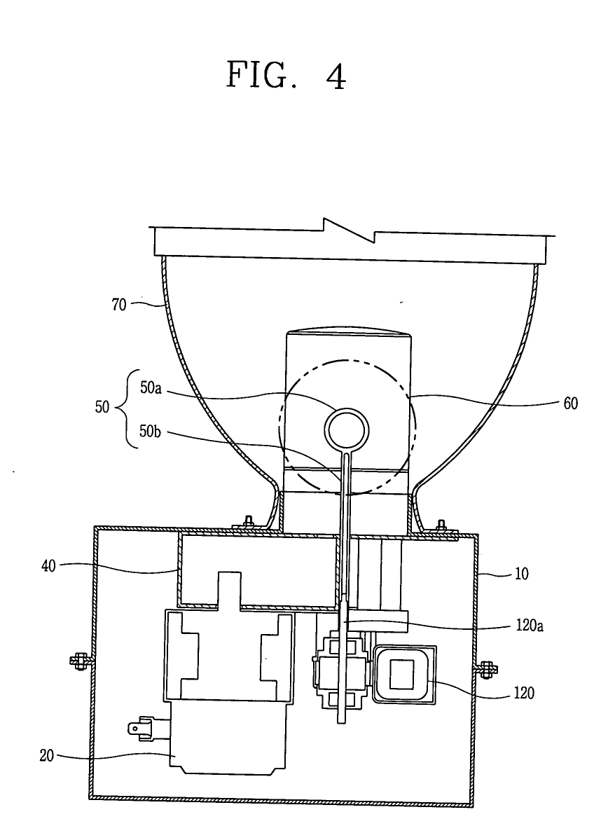

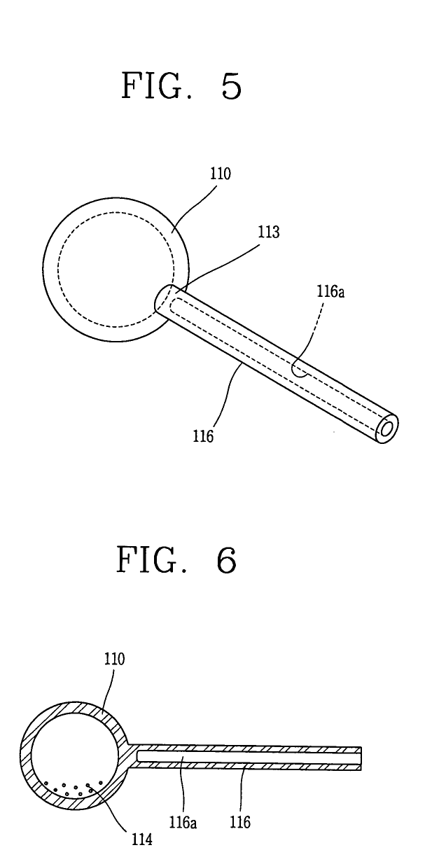

FIG. 4 shows an electrodeless lighting system in accordance with one embodiment of the present invention, and FIGS. 5 and 6 show a bulb structure of the electrodeless lighting system in accordance with one embodiment of the present invention.

As shown, the electrodeless lighting system in accordance with one embodiment of the present invention includes: a case 10 forming a certain interior space; a microwave generator 20 mounted in the case 10, for generating microwave energy; a waveguide 40 for guiding microwave energy generated at the microwave generator 20; a resonator 60 installed, communicating with the waveguide 40; and a bulb 50 positioned in the resonator 60, for generating light as a luminous material 114 filled therein becomes a plasma by microwave energy transferred through the waveguide 40.

In addition, a reflecting mirror 70 for concentratively reflecting light generated at the bulb 60 to the front is provided in front of the case 10, namely at a surrounding area of the resonator 60.

Undescribed reference mark 120 is a bulb rotating motor for rotating the bulb 5, and 120a is a bulb motor rotating shaft.

The bulb 50 includes: a bulb body 110 having an interior space receiving a luminous material 114 emitting light by microwave energy; a bulb support portion 116 integrally extending from one side of the bulb body 110 to communicate with the bulb body 110, supporting the bulb body 110, connected to the bulb rotating motor 120 at its one end, and having therein a passage 116a through which the luminous material 114 is injected; and a cover portion 113 formed at an inner communicating portion 112 where the bulb body 110 and the bulb support portion 116 communicate with each other, for hermetically sealing the bulb body 110.

The bulb body 110 is formed as a spherical shape whose surface is sleek except a portion connected to the bulb support portion 116.

Preferably, the bulb support portion 116 is formed as a hollow pipe shape having a through hole which becomes an injection passage 116a of the luminous material 114 at its central portion in a longitudinal direction, so that the luminous material 114 is injected and received easily in the interior space of the bulb body 110.

Also, the cover portion 113 is formed at the inner communicating portion 112 where the bulb body 110 and the bulb support portion 116 communicate with each other in order to prevent the luminous material 114 received in the interior space of the bulb body 110 from being leaked to the outside through the passage 116a of the bulb support portion 116. At this time, the cover portion 113 is formed by welding the inner communicating portion 112 of the bulb body 110 and the bulb support portion 116.

Also, like a bulb structure in accordance with another embodiment shown in FIG. 9, the communicating portion 112 can be covered by a covering member 120 inserted through the injection passage 116a of the bulb support portion 116.

At this time, the covering member 120 is preferably fitted to the communicating portion 112 by a forced fit method. However, the covering member 120 may be fitted thereto by other covering methods besides the forced fit method.

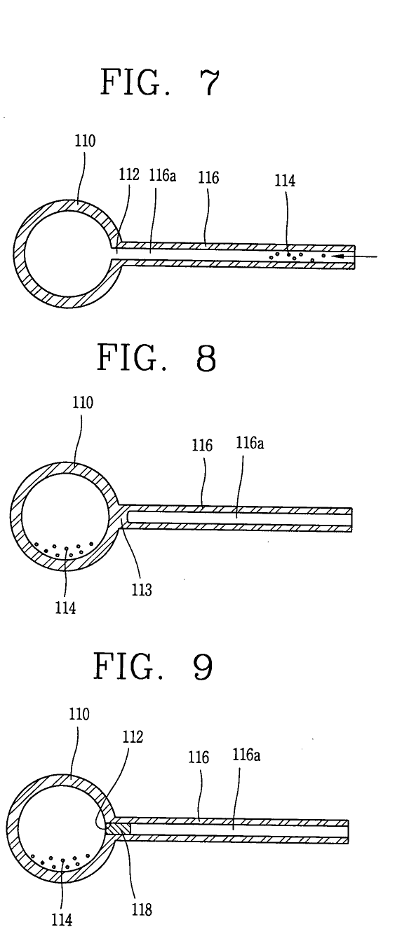

FIGS. 7 and 8 show a bulb manufacturing method of the electrodeless lighting system in accordance with one embodiment of the present invention.

As shown, the bulb manufacturing method of the electrodeless lighting system in accordance with one embodiment of the present invention includes: a first step of integrally forming a bulb support portion 116 having therein a passage 116a through which a luminous material emitting light by microwave energy is injected at one side of a bulb body 110 having an interior space receiving the luminous material 114, the bulb support portion communicating with the bulb body 110; a second step of injecting the luminous material 114 in the interior space of the bulb body 110 through the injection passage 116a of the bulb support portion 116; and a third step of forming a covering portion 113 at an inner communicating portion 112 where the bulb body 110 communicates with the bulb support portion 110 so that the interior space of the bulb body 110 having received the luminous material 114 is hermetically sealed.

In third step, the covering portion 113 is preferably formed by welding the inner communicating portion 112 of the bulb body 110 and the bulb support body 116. However, like another embodiment of the present invention described above, the communicating portion 112 may be closed by a covering member 118 inserted through the injection passage 116a of the bulb support portion 116.

It is preferable to fit the covering member 118 to the communicating portion 112 by a forced fit method, but the covering member 120 may be fitted thereto by other methods besides the forced fit method.

As so far described, the bulb of the electrodeless lighting system in accordance with the present invention is formed in such a manner that a bulb support portion supporting a spherical bulb body and having therein a passage for injection of a luminous material into the bulb body is integrally formed at one side of the bulb body, communicating therewith, a luminous material is received in an interior space of the bulb body through the injection passage of the bulb support portion, and then a communicating portion of the bulb body and the bulb support portion is covered. Thus, a protrusion resulted from the sealing of an interior space of the bulb in which a luminous material is filled does not remain at a surface of the bulb body. Accordingly, unlike the conventional art, refraction of light due to the protrusion does not occur in the present invention, so that light distribution characteristics of the electrodeless lighting system can be improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A bulb structure of an electrodeless lighting system comprising:
a bulb body having an interior space receiving a luminous material emitting light by microwave energy;
a bulb support portion integrally extending from one side of the bulb body to communicate with the bulb body, supporting the bulb body, connected to a bulb rotating motor at its one end, and having therein a passage through which the luminous material is injected; and
a covering portion formed at an inner communicating portion where the bulb body communicates with the bulb support portion, so as to hermetically seal the bulb body.

2. The bulb structure of claim 1, wherein the covering portion is formed by welding of the inner communicating portion of the bulb body communicates and the bulb support portion.

3. The bulb structure of claim 1, wherein the communicating portion is covered by a covering member inserted through the injection passage of the bulb support portion.

4. The bulb structure of claim 3, wherein the covering member is fitted to the communicating portion by a force fit method.

5. The bulb structure of claim 1, wherein the bulb support portion has a hollow pipe shape.

6. A bulb manufacturing method of an electrodeless lighting system comprising:
a first step of integrally forming a bulb support portion having therein a passage for injection of the luminous material at one side of a bulb body having an interior space receiving a luminous material emitting light by microwave energy, the bulb support portion communicating with the bulb body;
a second step of injecting the luminous material in the interior space of the bulb body through the injection passage of the bulb support portion; and
a third step of forming a covering portion at an inner communicating portion where the bulb body communicates with the bulb support portion so that the interior space of the bulb body in which the luminous material is filled is hermetically sealed.

7. The method of claim 6, wherein, in the third step, the covering portion is formed by welding of the inner communicating portion of the bulb body and the bulb support portion.

8. The method of claim 6, wherein, in the third step, the communicating portion is covered by a covering member inserted through the injection passage of the bulb support portion.

9. The method of claim 8, wherein the covering member is fitted to the communicating portion by a forced fit method.
